(19) United States
(12) Patent Application Publication
(10) Pub. No.: US 2002/0162425 A1
(43) Pub. Date: Nov. 7, 2002

(54) Lug nut wrench assembly

(76) Inventor: Ernie Castrorao, North Plainfield, NJ (US)

Correspondence Address: Paul Gauer, 347 Franklin Street, Bloomfield, NJ, 07003, US

(21) Appl. No.: 09/850,011

(22) Filed: May 7, 2001

(51) Int. Cl. B25B 23/16

(52) U.S. Cl. 81/177.5

(57) ABSTRACT

A lug nut wrench assembly consisting of a torque bar wherein one end of a socket extender is centrally matingly inserted and the opposite end of the socket extender matingly accepts commercially available sockets, all used in conjunction with a template for determining the correct size socket for the vehicle's lug nut.

This invention relates generally to automotive tools and more particularly to lug wrenches for changing tires.

### BACKGROUND ART

Removing the lug nuts for purpose of changing a tire is known to be an awkward task. As a result, a few inventors have patented devices to assist in removal of lug nuts.

U.S. Pat. No. 5,367,732 to Donald R. Suggs filed Dec. 7, 1992 describes a lug wrench with a forked handle.

U.S. Pat. No. 5,201,257 to Darryl L. Engel filed Jan. 13, 1992 has a socket pivotally attached to a handle.

U.S. Pat. No. 5,921,157 to Roger & Marie Smith filed Apr. 27, 1997 for a ratchet torque wrench with two perpendicular leverage tubes.

U.S. Pat. No. 4,537,101 to Frank A. Eversole filed Dec. 12, 1983 describes a support assembly to removably mount a lug wrench.

U.S. Pat. No. 3,416,395 to Merlin T Hansen filed duly 24, 1967 depicts a barrel bore with a magazine for progressive storage of hex nuts.

These attempts date back to 1933 with a ratchet type lug wrench in U.S. Pat. No. 1,957,905 to R H Owen.

### OBJECTS OF THE INVENTION

An object of the invention is to create a collapsible lug wrench, which can be disassembled for storage.

Another object is to design the simplest lug nut wrench with a minimum number of parts.

A further object is to facilitate the use of commercially available sockets with additional application of torque.

A still further object is to use the most unobtrusive parts so that the disassembled version can be stored almost anywhere.

Yet, another object is to provide maximum torque in a wrench for removal of lug nuts.

Still another object is to develop a lug nut wrench inexpensive to manufacture.

### SUMMARY OF INVENTION

This lug nut wrench is comprised of four pieces: torque bar, socket extender, extender screw, and lug nut template. The user places the template over the vehicle lug nut to determine the correct size. Then the correct size commercially available socket is inserted onto one end of the socket extender. The opposite end of the socket extender fits into the torque bar and is held in place by an extender screw.

### DESCRIPTION OF DRAWINGS

FIG. 1. Perspective view disassembled

FIG. 2. Perspective view assembled

FIG. 3. Top view of template

### BEST MODE OF PRACTICE

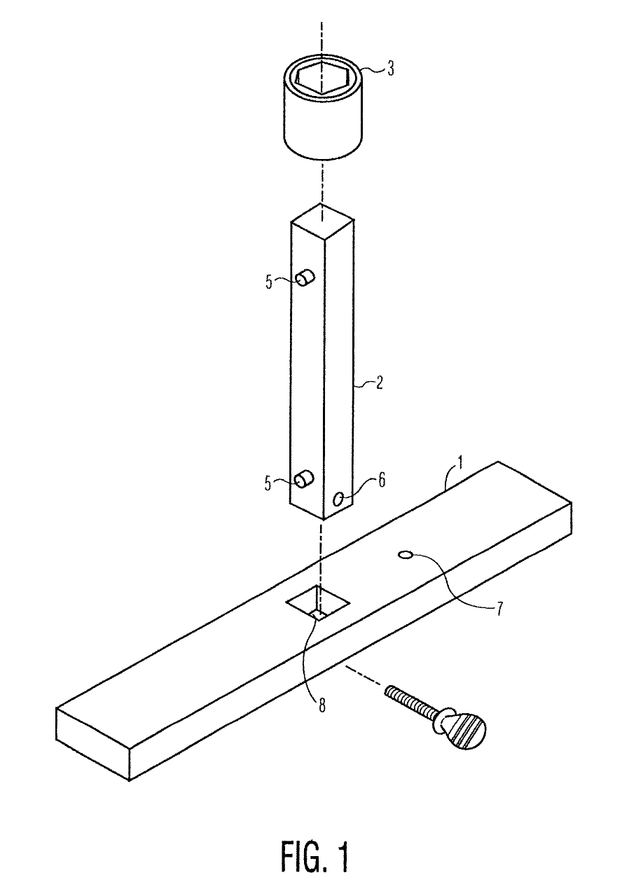

In FIG. 1. a torque bar (1) has a centered opening (8) for mating insertion of one end of socket extender (2). The opposite end of the socket extender (2) matingly accepts a commercially available socket (3) up to stop dowel (5). Torque bar (1) matingly accepts socket extender (2) up to stop dowel (5) and is further secured by an extender screw (4) which fits through hole (6) in the socket extender (2). When disassembled the extender screw (4) fits in storage hole (7) and extender hole (6) binding the torque bar (1) and socket extender (2) together side by side.

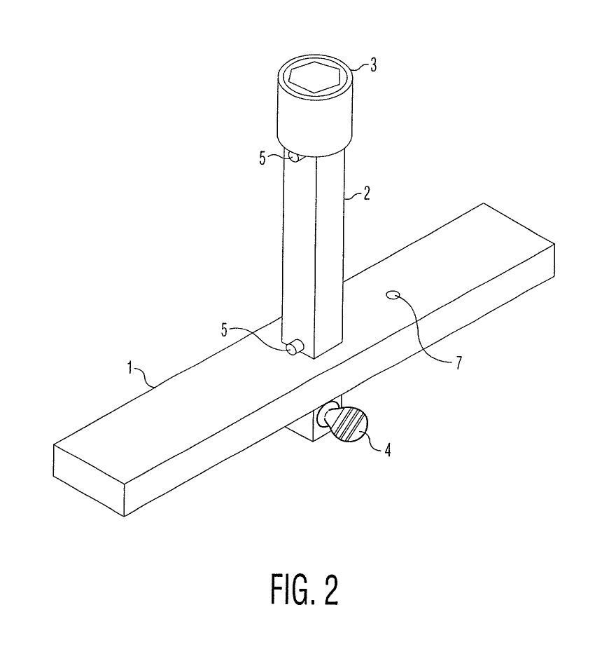

In FIG. 2. the torque bar (1) has inserted into it one end of the socket extender (2) which is held in place by extender screw (4) and stop dowel (5). At the opposite end of the socket extender (2) matingly sits a commercially available socket (3) up to stop dowel (5). Also shown is storage hole (7) not in use here.

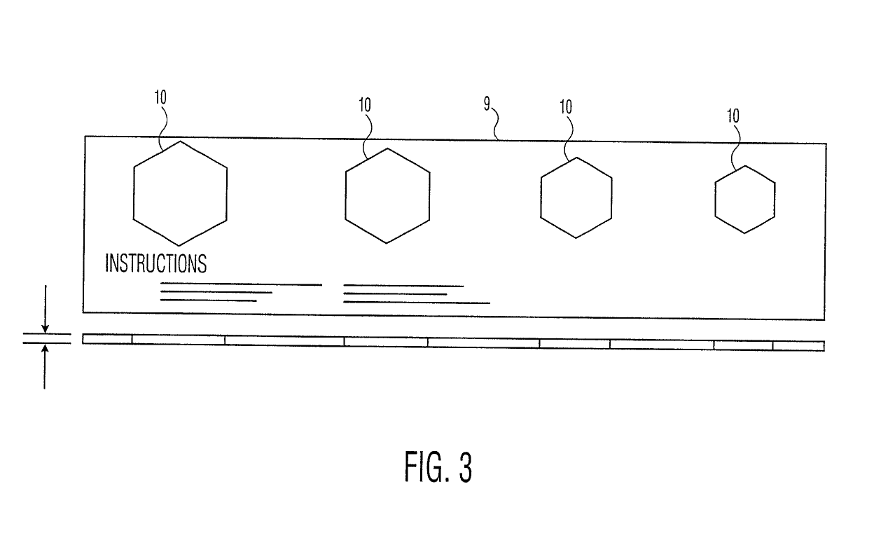

In FIG. 3. displays a template (9) with four alternative sized lug nut holes (10) and with instructions for assembly and use of the lug nut wrench assembly.

The inventor claims:

1. A lug nut wrench assembly comprised of a torque bar, which perpendicularly matingly accepts one end of a socket extender whose opposite end matingly fits a commercially available socket.

2. A lug nut template with two or more alternate size holes for checking lug nut sizes.

3. The lug nut wrench assembly of claim 1 having means for fastening the torque bar and socket extender.

4. The lug nut wrench assembly of claim 3 wherein one means for fastening is a spade thumb screw.

5. The lug nut wrench assembly of claim 3 wherein one means for fastening is a stop dowel.

6. The lug nut wrench assembly of claim 4 having a storage hole for the fastening screw.

7. The lug nut wrench assembly of claim 1 wherein the hole in the torque bar for acceptance of the socket extender is centered.

8. The lug nut wrench assembly of claim 1 wherein the hole in the torque bar for acceptance of the socket extender is square.

9. The lug nut wrench assembly of claim 1 wherein the socket extender has two male ends.
